(19) United States
(12) Patent Application Publication
(10) Pub. No.: US 2014/0293054 A1
(43) Pub. Date: Oct. 2, 2014

(54) OPTICAL DEVICE FOR A VEHICLE

(71) Applicant: Continental Automotive GmbH, Hannover (DE)

(72) Inventor: Victor Tomescu, Arad (RO)

(21) Appl. No.: 14/350,877

(22) PCT Filed: Oct. 11, 2012
(86) PCT No.: PCT/DE2012/100318

§ 371 Date: Apr. 10, 2014

(30) Foreign Application Priority Data
Oct. 20, 2011 (DE) 10 2011 116 388.7

(51) Int. Cl. B60R 11/04

(52) U.S. Cl. CPC B60R 11/04; B60R 2011/0026
USPC 348/148

(57) ABSTRACT

An optical device and a camera for a vehicle, which is arranged inside the vehicle behind the windscreen, including at least one optical module for detecting electromagnetic radiation, including an imaging system and an image recording element, and including at least one circuit board on which image evaluation electronics is arranged and which is electrically connected to the at least one optical module, wherein the at least one circuit board is arranged substantially parallel to the windscreen.

### CROSS REFERENCE TO RELATED APPLICATIONS

This application is the U.S. National Phase Application of PCT/DE2012/100318, filed Nov. 10, 2012, which claims priority to German Patent Application No. 10 2011 116 388.7, filed Oct. 20, 2011, the contents of such applications being incorporated by reference herein.

### FIELD OF THE INVENTION

The invention relates to an optical device for a vehicle, which is preferably arranged inside the vehicle behind a windscreen.

### BACKGROUND OF THE INVENTION

Driver assistance systems in vehicles often use an optical device to scan the surroundings of the vehicle, for example in the form of a camera for detecting the most varied objects in the area around the vehicle.

As a rule, said camera is arranged behind the windscreen of the vehicle and looks through the windscreen in the direction of travel. Examples are vehicle cameras for the detection of objects, obstacles and road surface markings, night vision cameras, or stereo cameras used as optical distance sensors.

Vehicle cameras typically comprise an objective and a light-sensitive image sensor which is arranged at right angles to the optical axis of the objective. Said optical axis of the objective is aligned in a substantially horizontal direction in order to be able to scan an appropriate area ahead of the vehicle.

To prevent cameras arranged behind the windscreen from overly limiting the field of vision of the driver and to save installation space, which is only available to a limited extent in the vehicle, in particular if further sensor systems are arranged behind the windscreen, vehicle cameras must be designed and arranged in the vehicle in a more and more compact and space-saving manner.

DE 102 37 606 B4, which is incorporated by reference, attempts to meet this requirement by using the installation space below the optical axis of the objective to arrange the image evaluation electronics needed for image evaluation. For this purpose, DE 102 37 606 B4 proposes to arrange a first circuit board including an image sensor located thereon behind the objective and at right angles to the optical axis thereof and to arrange a second circuit board including the image evaluation electronics below the optical axis of the objective and in a substantially horizontal direction to said axis. However, it is an important drawback of the proposed arrangement that installation space behind the objective is still needed to arrange the image sensor and the image evaluation electronics is arranged on a separate circuit board. This entails considerable effort and, in consequence, costs.

### SUMMARY OF THE INVENTION

An aspect of the invention provides an optical device for a vehicle, which is designed as space-saving and compact as possible.

This is achieved by means of an optical device for a vehicle, which is arranged inside the vehicle behind the windscreen, comprising at least one optical module for detecting electromagnetic radiation, comprising an imaging system for projecting the electromagnetic radiation, and an image recording element having a surface that is sensitive to electromagnetic radiation for detecting the electromagnetic radiation projected by the imaging system, and at least one circuit board, on which image evaluation electronics is arranged and which is electrically connected to the at least one optical module, wherein the at least one circuit board is arranged substantially parallel to the windscreen and a camera incorporating the optical device. Advantageous configurations and further developments are set out in the dependent claims; combinations and further developments of individual features with each other are also possible.

It is an essential idea of the invention to preferably design an optical device with an optical module, which comprises an objective or an imaging system and an image sensor or an image recording element, and with a circuit board on which image evaluation electronics is arranged, wherein the circuit board is formed with an opening or a hole for the optical module to look through. The circuit board including the image evaluation electronics can be arranged inside the vehicle in a particularly space-saving manner, substantially parallel to the windscreen. The optical module is electrically connected to the circuit board, and both are preferably arranged in a shared housing. According to an aspect of the invention, the circuit board may also be designed without an opening and arranged parallel to the windscreen beside an area of view of the optical module. This also results in a particularly space-saving structure.

The device according to an aspect of the invention comprises at least one optical module, which serves to detect electromagnetic radiation. The optical module comprises at least one imaging system and at least one image recording element.

The imaging system is preferably an objective, which may comprise one or several lenses as well as other optical beam-shaping or beam-directing elements. The imaging system serves, in particular, to project electromagnetic radiation, especially electromagnetic radiation from a surrounding area ahead of the vehicle, onto the image recording element or an image plane located behind the imaging system. The electromagnetic radiation is preferably electromagnetic radiation within the visible spectral range and/or electromagnetic radiation within the infrared and/or ultraviolet range.

The image recording element is preferably a light-sensitive semiconductor image sensor, for example a CCD or CMOS image sensor, including a surface that is sensitive to electromagnetic radiation. The image recording element serves, in particular, to detect the electromagnetic radiation projected by means of the imaging system and to generate and/or output electrical signals in accordance with the electromagnetic radiation that has been detected.

In particular if the imaging system is designed as an objective, which, as a rule, comprises one or several lenses arranged as a stack of lenses within an objective housing, the imaging system and the image recording element may be formed with a shared housing, for example by integrating the image recording element in the objective housing.

The optical device further comprises at least one circuit board on which image evaluation electronics is arranged.

The image evaluation electronics is preferably electronic units which serve to evaluate the electromagnetic radiation detected by means of the optical module or the electrical signals generated by means of the image recording element. The electronic units are, for example, electrical circuits and microprocessors for carrying out image processing algorithms.

The circuit board on which the image evaluation electronics is arranged is, in particular, electrically connected to the image recording element. The electrical connection is preferably made by means of flexible cables or strip contacts. The circuit board may, for example, be a PCB (printed circuit board).

According to an aspect of the invention, the circuit board on which the image evaluation electronics is arranged is preferably designed with at least one opening, in particular with a round or angular opening or with an opening in the form of a hole or an aperture in the circuit board.

The circuit board is further arranged inside the vehicle substantially parallel to the windscreen, in particular directly or at a small distance behind the windscreen. “Arranged substantially parallel to or behind the windscreen” preferably means that the circuit board is arranged exactly parallel to the windscreen, although a certain deviation from said parallel arrangement is possible, for example an angular deviation by +/−10°. For example, it may be necessary to deviate from the parallel arrangement due to different angles of inclination of vehicle windows or the windscreens behind which the optical device may be arranged. The inclinations of windscreens, in particular in the upper part of the screens, may range from 20° to 35°, which means that the optical device according to an aspect of the invention must be adapted.

According to an aspect of the invention, the optical module of the optical device is preferably arranged in such a manner, in particular if the circuit board is designed with at least one opening, that the optical module detects the electromagnetic radiation through the at least one opening in the circuit board, i.e. the view of the optical module is directed to the relevant vehicle window or to a surrounding area ahead of the vehicle and the optical module looks through the circuit board. The electromagnetic radiation which is incident on the optical module or on the imaging system is incident through the opening in the circuit board.

According to an aspect of the invention, the circuit board on which the image evaluation electronics is arranged may also be arranged substantially parallel behind the windscreen beside an area of detection or outside the field of view of the optical module. “Area of detection” means, in particular, the area of the windscreen through which the optical module detects electromagnetic radiation, for example from the surroundings of the vehicle. This area is often also referred to as area of vision or area of view. The circuit board may, for example, be arranged beside the area of detection of the optical module, i.e., for example, above, below and/or to the side of the area of detection, and substantially parallel to the windscreen. If the circuit board is arranged outside the area of detection and substantially parallel to the windscreen, the circuit board may preferably be designed without an opening.

In a special configuration of the optical device according to an aspect of the invention, the optical module is arranged such that at least part of the optical module extends into the at least one opening in the at least one circuit board or through said opening. In this case, the circuit board may, for example, be arranged at a small distance behind the windscreen, and at least part of the optical module passes through the at least one opening in the circuit board, from the interior of the vehicle towards the windscreen.

In a preferred configuration of. the optical device according to an aspect of the invention, the circuit board including the image evaluation electronics is aligned exactly parallel to the windscreen and arranged, in particular, inside the vehicle at the smallest possible distance behind the windscreen, e.g. by means of housing elements and/or holding devices located between the windscreen and the circuit board.

In another preferred configuration of the optical device according to an aspect of the invention, the optical device comprises at least one housing in which, in particular, the circuit board on which the image evaluation electronics is arranged and the optical module are arranged. In this case, the housing may be fixed directly to the windscreen, for example by means of an adhesive connection and/or a holding device which is designed for this purpose and secured to the windscreen.

In an advantageous configuration of the optical device according to an aspect of the invention, the optical module is connected to the housing of the optical device or arranged in said housing by means of an adjustable holding device. The adjustable holding device is, for example, a holding device which can be adjusted mechanically. The holding device is preferably designed such that the holding device can be used to adjust the detection angle of the optical module. “Detection angle” means, in particular, the angle of the optical axis of the optical module to the horizon or to a horizontal alignment. The detection angle is adjusted, for example, in order to change the area of observation of the optical module or the optical device and/or to adapt the optical device to the angle of inclination of the windscreen behind which the optical device is arranged.

If the optical device according to an aspect of the invention is configured in this way, the optical device can be arranged behind a windscreen, and the device can easily be adapted to the particular installation conditions and/or the particular inclination of the screen. This means, it is preferably possible not to tailor the optical device to different types of vehicles or installation conditions, and the optical device can be used in a large number of ways.

The optical device according to an aspect of the invention is preferably arranged in a camera for a vehicle.

### BRIEF DESCRIPTION OF THE DRAWINGS

Further advantages and optional configurations can be seen from the description and the drawings. Exemplary embodiments are shown in the drawings in a simplified manner and explained in detail in the description below.

FIG. 1 shows a schematic side view of a preferred configuration of the optical device according to an aspect of the invention.

FIG. 2 shows an example of an optical device according to an aspect of the invention from the perspective of the electromagnetic radiation 8 which is incident on the optical module 2 of the optical device.

### DETAILED DESCRIPTION OF THE INVENTION

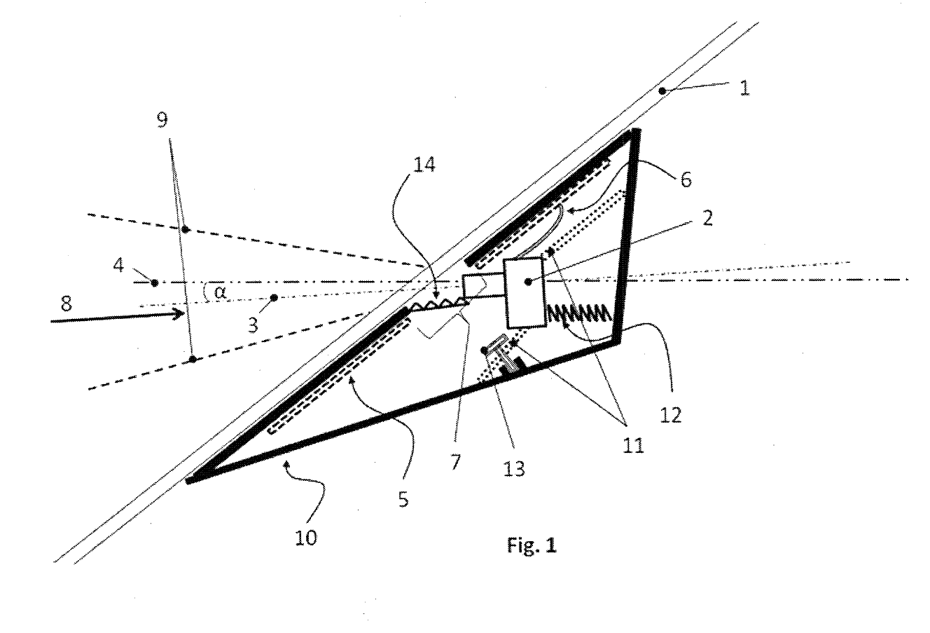

FIG. 1 shows a schematic side view of a preferred configuration of the optical device according to an aspect of the invention. The optical device is arranged behind the windscreen 1 of a vehicle and comprises an optical module 2 including an imaging system and an image recording element, which are arranged in a shared housing. The optical axis 3 of the optical module 2 is aligned in a substantially horizontal direction, wherein “substantially horizontal direction” includes an angle of inclination a in the range of +/−45° to the exactly horizontal alignment 4 in this case. The optical device further comprises a circuit board 5, on which image evaluation electronics (not shown) is arranged. The circuit board on which the image evaluation electronics is arranged is electrically connected to the, image recording element. In this case, the electrical connection is made by means of flexible cables 6 arranged between the optical module 2 and the circuit board 5. Within the optical module, the cables 6 may, for example, be connected to a circuit board on which the image recording element is arranged.

According to an aspect of the invention, the circuit board 5 on which the image evaluation electronics is arranged is designed with at least one opening 7, in this case with an opening 7 in the form of a hole or an aperture in the circuit board 5.

Furthermore, the circuit board 5 is arranged parallel to the windscreen 1 and, in this case, at a small distance behind the windscreen 1.

According to an aspect of the invention, the optical module 2 of the optical device is arranged such that the optical module 2 detects the electromagnetic radiation 8 through the at least one opening 7 in the circuit board 5, i.e. the optical module 2 is aligned in such a manner that its direction of observation or area of observation 9 is towards the vehicle window 1 and/or a surrounding area ahead of the vehicle. The electromagnetic radiation which is incident on the optical module 2 or on the imaging system of the optical module 2 is incident through the opening 7 in the circuit board 5.

The optical device according to FIG. 1 further comprises a housing 10 in which the circuit board 5 and the optical module 2 are arranged. In this case, the housing 10 is fixed directly to the windscreen 1, for example by means of an adhesive connection.

In the example of FIG. 1, the optical module 2 is connected to the housing 10 of the optical device or arranged in said housing 10 by means of an adjustable holding device. In this case, the adjustable holding device is a holding device which can be adjusted mechanically and comprises connecting elements 11 between the optical module 2 and the housing 10 as well as a spring 12 and an adjustment screw 13. The holding device is, in particular, designed such that the adjustment screw 13 can be used to adjust the detection angle α of the optical module 2. The detection angle α is adjusted, for example, in order to change the area of observation 9 of the optical module 2 or the optical device and/or to adapt the optical device to the angle of inclination of the windscreen 1.

An additional component included in the optical device of FIG. 1 is a lens hood 14 arranged between the optical module 2 and the housing 10.

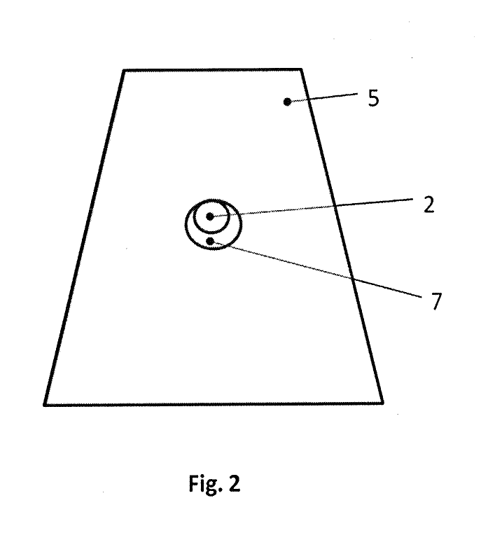

FIG. 2 shows an example of an optical device according to an aspect of the invention from the perspective of the electromagnetic radiation 8 which is incident on the optical module 2 of the optical device. FIG. 2 shows the circuit board 5, which is designed with a round opening 7 in this case. The optical module 2 is arranged behind the circuit board 5 and, according to an aspect of the invention, so as to look through the opening 7 of the circuit board 5 or to detect the electromagnetic radiation 8 (not shown in FIG. 2) through the opening 7. The optical device of FIG. 2 may, for example, comprise a housing 10 and be arranged directly behind the windscreen 1 of a vehicle, as shown in FIG. 1, in particular in such a manner that the circuit board 5 is aligned substantially parallel to the windscreen 1.

According to an aspect of the invention, the optical devices of FIG. 1 and FIG. 2 may be designed as vehicle cameras and comprise additional elements, such as, for example, holding or fixing devices as well as electrical connecting elements to other electronic units within the vehicle. The optical devices and their components may also be made of several parts and have other shapes and configurations than those shown in FIGS. 1 and 2.

### LIST OF REFERENCE NUMERALS

1 Windscreen

2 Optical module

3 Optical axis

4 Horizontal alignment

5 Circuit board

6 Electrical connection

7 Opening

8 Electromagnetic radiation

9 Area of observation

10 Housing

11 Connecting elements

12 Spring

13 Adjustment screw

14 Lens hood

α Detection angle

1. An optical device for a vehicle, which is arranged inside the vehicle behind the windscreen, comprising:
at least one optical module for detecting electromagnetic radiation, comprising:
an imaging system for projecting the electromagnetic radiation, and
an image recording element having a surface that is sensitive to electromagnetic radiation for detecting the electromagnetic radiation projected by the imaging system, and
at least one circuit board, on which image evaluation electronics is arranged and which is electrically connected to the at least one optical module,
wherein
the at least one circuit board is arranged substantially parallel to the windscreen;
wherein the at least one circuit board is formed with at least one opening, and the optical module is arranged such that the optical module detects the electromagnetic radiation through the at least one opening.

2. The optical device according to claim 1, wherein the at least one circuit board is arranged behind the windscreen beside an area of detection of the optical module, and wherein the area of detection is an area of the windscreen through which the optical module detects the electromagnetic radiation.

3. (canceled)

4. The optical device according to claim 1, wherein the optical module is arranged such that part of the optical module extends into the at least one opening in the at least one circuit board.

5. The optical device according to claim 1, wherein the at least one circuit board is arranged parallel to the windscreen.

6. The optical device according to claim 1, wherein the optical device comprises a housing in which the at least one circuit board and the at least one optical module are arranged.

7. The optical device according to claim 6, wherein the optical module is connected to the housing by an adjustable holder, in such a manner that the adjustable holder can be used to change a detection angle (α) of the optical module.

8. A camera for a vehicle, comprising an optical device according to claim 1.

9. A vehicle in which an optical device according to claim 1 is arranged.

10. A vehicle in which a camera comprising an optical device according to claim 1 is arranged.
